(19) United States
(12) Patent Application Publication
(10) Pub. No.: US 2025/0249401 A1
(43) Pub. Date: Aug. 7, 2025

(54) CARBON DIOXIDE RECOVERY DEVICE

(71) Applicant: HONDA MOTOR CO., LTD., Tokyo (JP)

(72) Inventors: Masanobu TAKAZAWA, Saitama (JP); Shumon HOSHINO, Saitama (JP)

(21) Appl. No.: 19/043,535

(22) Filed: Feb. 3, 2025

(30) Foreign Application Priority Data
Feb. 5, 2024 (JP) 2024-015535

(51) Int. Cl. B01D 53/62; B01D 53/34; B01D 53/82; B01D 53/96

(52) U.S. Cl. CPC B01D 53/62; B01D 53/346; B01D 53/82; B01D 53/96; B01D 2253/20; B01D 2257/504; B01D 2258/06; B01D 2259/40088

(57) ABSTRACT

A carbon dioxide recovery device includes: a plurality of modules, each one executing an adsorption process of adsorbing carbon dioxide; and a desorption process of desorbing the carbon dioxide; a fan that supplies a gas to inside of the module; a heat source that heats the sorbent material of the module; and a first vacuum pump and second vacuum pump that aspirate a gas inside of the module, in which at least one among the fan, the heat source and the first vacuum pump and the second vacuum pump is shared between the plurality of the modules, and a number M of the modules is set based on Equation below, when defining a natural number as N and a ratio obtained by dividing an adsorption time of the sorbent material by a desorption time as R.

$$M = N \times ( R + 1 ) \qquad Equation ( 1 )$$

This application is based on and claims the benefit of priority from Japanese Patent Application No. 2024-015535, filed on 5 Feb. 2024, the content of which is incorporated herein by reference.

### BACKGROUND OF THE INVENTION

### Field of the Invention

The present invention relates to a carbon dioxide recovery device.

### Related Art

Conventionally, technology for recovering carbon dioxide from a gas which contains carbon dioxide such as atmospheric air has been known. As a document disclosing this type of technology, Japanese Unexamined Patent Application (Translation of PCT Application), Publication No. 2017-528318 can be exemplified. Japanese Unexamined Patent Application (Translation of PCT Application), Publication No. 2017-528318 discloses a method of separating gaseous carbon dioxide from a gas mixture by cyclic adsorption/desorption using an adsorbent which adsorbs gaseous carbon dioxide.
Patent Document 1: Japanese Unexamined Patent Application (Translation of PCT Application), Publication No. 2017-528318

### SUMMARY OF THE INVENTION

In the case of configuring a carbon dioxide recovery device with a single large sorbent material, the configurations of each piece of equipment such as a fan, a vacuum pump, and a heat source will intermittently operate in the adsorption process and the desorption process. Intermittent operation requires momentary large outputs.

By dividing the sorbent material among a plurality of modules and staggering the operation timings, it is possible to use a small capacity, low cost equipment, without lowering the carbon dioxide recovery amount per unit time. However, even if staggering the operation timings, it is difficult to uniformly distribute the output, and there has been room for improvement in the conventional technology from the viewpoint of efficiently controlling a plurality of modules.

The present invention has an object of providing a carbon dioxide recovery device that can efficiently perform control of a plurality of modules having a sorbent material.

A first aspect of the present invention relates to a carbon dioxide recovery device (for example, the carbon dioxide recovery device 1 described later) including: a plurality of modules (for example, the module 11 described later), each one including a sorbent material (for example, the sorbent material 12 described later) inside thereof, and executing an adsorption process of aspirating a gas containing carbon dioxide and adsorbing the carbon dioxide to the sorbent material; and a desorption process of desorbing the carbon dioxide from the sorbent material by heating in a state where a periphery of the sorbent material is reduced pressure; a fan (for example, the fan 20 described later) that supplies a gas to inside of the module; a heat source (for example, the heat source 23 described later) that performs heat supply for heating the sorbent material of the module; and a vacuum pump (for example, the first vacuum pump 21 and the second vacuum pump 22 described later) that aspirates a gas inside of the module, in which at least one among the fan, the heat source and the vacuum pump is shared between the plurality of the modules, and a number M of the modules is set based on Equation (1) below, when defining a natural number as N and a ratio obtained by dividing an adsorption time of the sorbent material by a desorption time as R.

M=N×(R+1) Equation (1)

According to a second aspect of the present invention, in the carbon dioxide recovery device as described in the first aspect, respective processing for executing the adsorption process and the desorption process may be executed in a staggered manner so as not to be performed at the same timing among the plurality of the modules.

According to a third aspect of the present invention, in the carbon dioxide recovery device as described in the second aspect, a time calculated by dividing a sum of the adsorption time and the desorption time by the number M of the modules may be set as a time difference of operation timings between the modules.

According to a fourth aspect of the present invention, in the carbon dioxide recovery device as described in the second or third aspect, the number M of the modules may be 10 or more.

According to the present invention, it is possible to provide a carbon dioxide recovery device that can efficiently perform control of a plurality of modules having a sorbent material.

### BRIEF DESCRIPTION OF THE DRAWINGS

FIG. 1 is a schematic diagram showing the configuration of a carbon dioxide recovery device according to an embodiment of the present invention;

FIG. 2 is a bar graph showing a cycle of the respective processing in an adsorption process and a desorption process according to the present embodiment;

FIG. 3 is a tree diagram showing influential factors on a ratio between adsorption time and desorption time;

FIG. 4 is a table showing the relationship between the respective processing of the adsorption process and the desorption process, and the time according to the present embodiment;

FIG. 5 is a graph showing a change in motive power of each piece of equipment with one module;

FIG. 6 is a graph showing a change in motive power of each piece of equipment with four modules;

FIG. 7 is a graph showing an example of the respective processing timings of eight modules;

FIG. 8 is a graph showing a relationship between the number of modules and an operational fluctuation range of a first vacuum pump; and

FIG. 9 is a graph showing a relationship between the number of modules and an operational fluctuation range of a second vacuum pump.

### DETAILED DESCRIPTION OF THE INVENTION

Hereinafter, embodiments of the present invention will be described by referencing the drawings.

### <Overall Configuration>

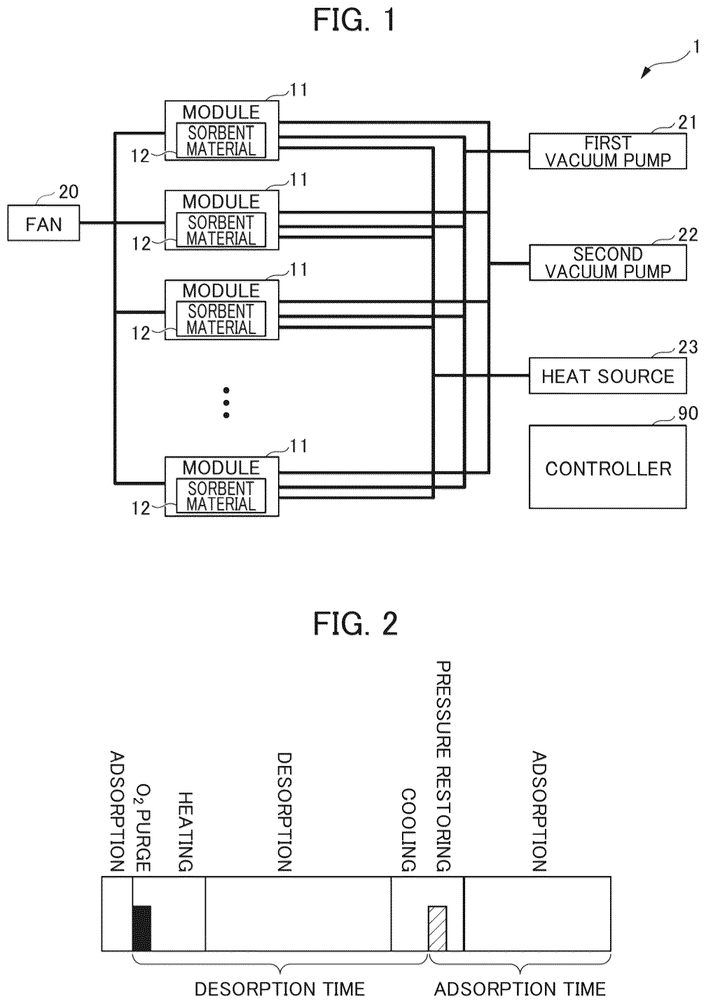

FIG. 1 is a schematic diagram showing the configuration of a carbon dioxide recovery device 1 according to an embodiment of the present invention.

The carbon dioxide recovery device 1 of the present embodiment, for example, is applied to direct air recovery technology (DAC: Direct Air Capture) which recovers the carbon dioxide in the atmosphere, in order to decrease the carbon dioxide concentration in the atmosphere. The carbon dioxide recovered by the carbon dioxide recovery device 1 is stored in the ground, and is reused as a fuel or raw material.

As shown in FIG. 1, the carbon dioxide recovery device 1 according to the present embodiment includes a plurality of modules 11, a fan 20, a first vacuum pump 21, a second vacuum pump 22, a heat source 23 and a controller 90.

The module 11 is a carbon dioxide recovery module including a sorbent material 12 that adsorbs carbon dioxide inside thereof. The sorbent material 12 is a member in particle form, and has a property of adsorbing carbon dioxide in a low-temperature state (for example, range of −30° C. to 50° C.), and desorbing (releasing) carbon dioxide in a state of high temperature (for example, range of 50° C. to 110° C.) and low concentration of carbon dioxide in the surroundings. As such a sorbent material 12, for example, a carbon dioxide sorbent material of a solid amine configured by supporting an amine on a porous material such as silica, or the like can be exemplified.

A plurality of the modules 11 are arranged. The module number is set based on the ratio of adsorption time and desorption time described later.

The fan 20 causes a flow of gas from “intake” to “exhaust” relative to the module 11 to be generated through the pipe by being driven. Atmospheric air is thereby supplied into the module 11. The fan 20 causes the flow of gas from “intake” to “exhaust” relative to a plurality of the modules 11 to be generated by branched and connected pipes.

The first vacuum pump 21 applies a suction force to feed the carbon dioxide desorbed from the sorbent material 12 inside of the module 11 to a tank (not shown) in the desorption process described later. The first vacuum pump 21 applies a suction force to the plurality of modules 11 by branched and connected pipes.

The second vacuum pump 22 reduces the pressure inside of the module 11 to cause a suction force of a vacuum state or nearly a vacuum state to be applied. The second vacuum pump 22 causes a suction force to be applied to the plurality of modules 11 by the branched and connected pipes.

Upon each module 11 of the module unit 10 performing the desorption process, the heat source 23 supplies thermal energy for heating the sorbent material 12 inside of this module 11 up to a predetermined temperature. The heat source 23 of the present embodiment is also a heat exchange device which recovers thermal energy which is unneeded upon the module 11 performing adsorption. The heat source 23 performs the supply of thermal energy or recovery of thermal energy on each of the plurality of modules 11.

The heat source 23, for example, is configured by pipes connected to each module 11, a heat pump, etc. The heat source 23 may be a heater, or may be a steam generator.

The controller 90 controls operation of each part of the carbon dioxide recovery device 1. The controller 90 controls operations such as driving and stopping of devices used in adsorption and desorption of carbon dioxide. The controller 90 performs operation control of the fan 20, the first vacuum pump 21, the second vacuum pump 22, the heat source 23, etc.

The controller 90, for example, is a computer that has a CPU (Central Processing Unit), ROM (Read Only Memory), RAM (Random Access Memory), etc. The controller 90 may be configured as one unit, or may be configured by several units.

### <Relationship of Adsorption Process and Desorption Process>

The carbon dioxide recovery device 1 alternately performs an adsorption process of adsorbing carbon dioxide in a gas aspirated such as atmospheric air to the sorbent material 12 in the module 11, and a desorption process of desorbing the carbon dioxide adsorbed to the sorbent material 12, to remove carbon dioxide from the air.

A process for recovery carbon dioxide by way of the controller 90 will be described while referencing FIG. 2. FIG. 2 is a bar graph showing a cycle of the respective processing of the adsorption process and the desorption process according to the present embodiment.

The adsorption process is a process of adsorbing carbon dioxide to the sorbent material 12 in the module 11. In the adsorption process, adsorption processing to aspirate a gas containing carbon dioxide (for example, atmospheric air) is performed by the module 11 by driving the fan 20. The aspirated gas passes through the sorbent material 12 in the module 11. At this time, inside of the module 11 is room temperature (25° C.), and the carbon dioxide in the gas is adsorbed to the sorbent material 12. Gas other than carbon dioxide, for example, nitrogen and oxygen, is exhausted to outside of the carbon dioxide recovery device 1.

The desorption process is a process of desorbing the carbon dioxide on the sorbent material 12 inside of the module 11. In heating processing of the desorption process, thermal energy is supplied to the module 11 by the heat source 23, whereby the sorbent material 12 is heated to a predetermined temperature (for example, 90° C.) adequate for the desorption process. O₂ purge processing is executed in the heating processing. In the O₂ purge processing, the second vacuum pump 22 runs to aspirate and reduce the pressure inside of the module 11, and performs O₂ scavenging on the inside of the module 11 to a vacuum state or bring close to a vacuum state. In the desorption process, the carbon dioxide adsorbed to the sorbent material 12 is desorbed by the sorbent material 12, and the carbon dioxide is sent to a tank (not shown) by way of the first suction of the vacuum pump 21. Cooling processing is performed on the sorbent material 12 after the desorption processing.

Pressure-restoring processing of returning the pressure inside of the module 11 is executed during the cooling processing. The start of pressure-restoring processing serves as the start of the next adsorption process.

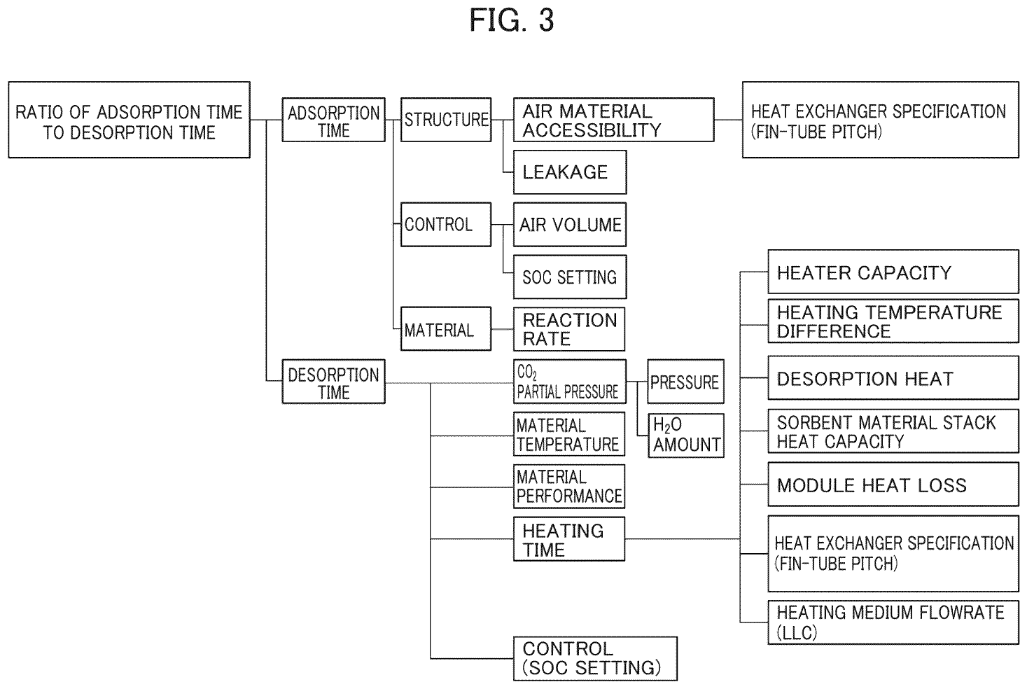

The adsorption time indicating the time of the adsorption process and the desorption time indicating the time of the desorption process are decided according to the device configuration, operating conditions, etc. Next, defining the ratio of the adsorption time and desorption time (adsorption time/desorption time) as R, an example of the influencing factors of the adsorption time and desorption time will be explained referencing FIG. 3. FIG. 3 is a tree diagram showing the influencing factors of the ratio R of the adsorption time and the desorption time.

As shown in FIG. 3, when generally classifying, the influencing factors deciding the adsorption time are divided into structure, control and materials. The structure is decided by the air material accessibility, leakage, etc. The heat exchanger specifications are heat exchanger specifications such as fin-tube pitch. The leakage is a leakage amount of gas in the module 11, etc. The control is the air volume and SOC setting. The SOC (State of Charge) setting is a range of carbon dioxide adsorption amount repeatedly performing adsorption and desorption by control. The material is based on the reaction rate of the sorbent material 12, etc.

Among the influencing factors of the adsorption time, the heat exchanger specification, leakage, air volume and SOC setting are specification settings including other performances. The reaction rate is decided based on the material constituting the sorbent material 12, etc. The reaction rate is an influence factor that is relatively difficult to control.

When generally classified, the influencing factors deciding the desorption time are divided into CO₂ partial pressure, material temperature, material performance, heating time, and control (SOC setting). The CO₂ partial pressure is decided by the internal pressure of the module 11 and the H₂O amount adsorbed to the sorbent material 12

The material temperature is the temperature of the sorbent material 12. The material performance is decided by the adsorption performance of the sorbent material 12, etc. The heating time is decided by the heater capacity of the heat source 23, heating temperature difference, desorption heat, stack volume of sorbent material 12, heat loss of the module 11, heat exchanger specifications such as fin-tube pitch, flowrate of heating medium such as antifreeze fluid (LLC liquid). The control is decided by the SOC setting.

Among the influencing factors of the desorption time, the pressure of the CO₂ partial pressure, H₂O amount, material temperature, heater capacity, desorption heat, stack volume of sorbent material 12, heat loss of the module 11, heat exchanger specifications such as fin-tube pitch, heating medium flowrate, and control (SOC setting) are specification settings including other performances. The material performance is an influence factor which is relatively difficult to control that is decided by the sorbent material 12 used.

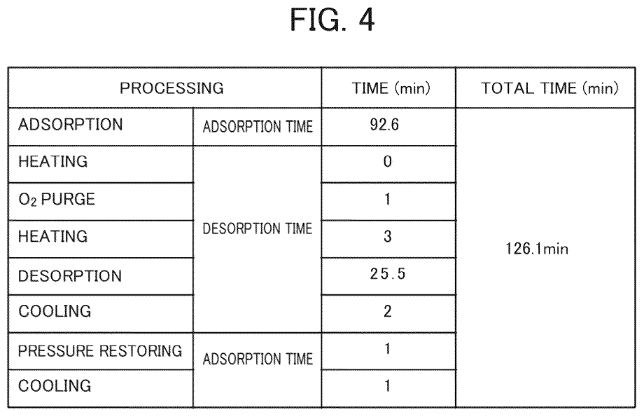

The ratio of adsorption time to desorption time (adsorption time/desorption time) is set based on such influencing factors. Next, a specific example of the ratio of adsorption time to desorption time (adsorption time/desorption time) will be described by referencing FIG. 4. FIG. 4 is a table showing the relationship between the respective processing of the adsorption process and desorption process, and time according to the present embodiment.

In the example shown in FIG. 4, the total time combining the respective processing times of the adsorption time is 94.6 minutes, and the total time combining the respective processing times of the desorption time is 31.5 minutes. The adsorption time is 3 times longer than the desorption time. The ratio of the adsorption time to the desorption time is calculated by rounding off less than one digit. When establishing a 90-minute adsorption time, 30-minute desorption time and 120-minute cycle, it will be adsorption time: desorption time=3:1, and thus the ratio (adsorption time/desorption time) R of adsorption time to desorption time becomes 3. Hereinafter, a case will be described in which the ratio (adsorption time/desorption time) R of the adsorption time to desorption time of the carbon dioxide recovery device 1 according to the present embodiment is 3.

### <Setting of Module Number>

Next, the method of setting the module number will be described. First, as a premise, a comparison between a case of performing the adsorption process and desorption process with one module 11, and a case of performing the adsorption process and desorption process with a plurality of (four) modules 11 will be described.

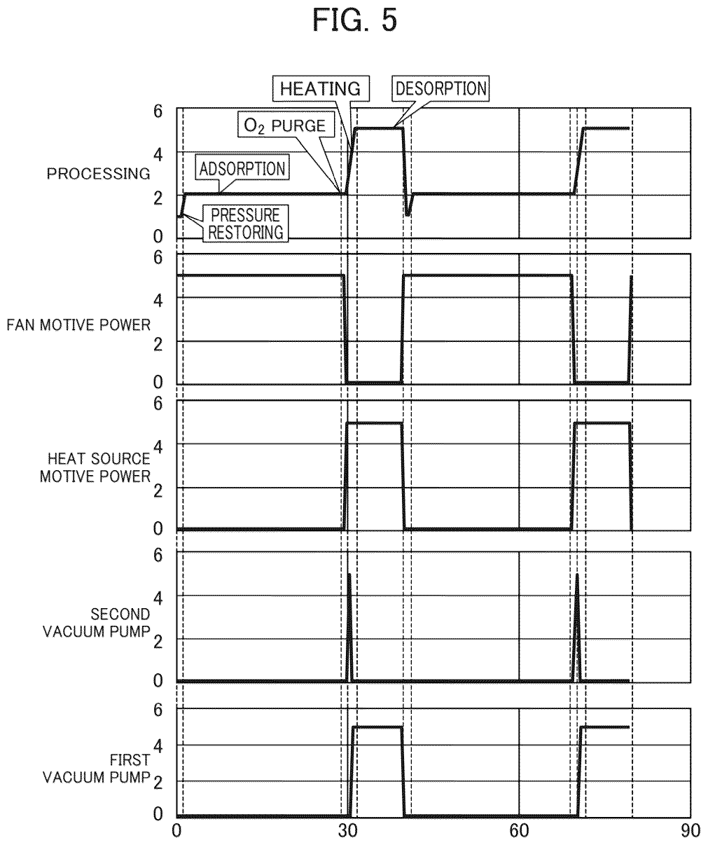

FIG. 5 is a graph showing the change in motive power of each piece of equipment in the first module 11. FIG. 5 shows the change in motive power (output) for the pan 20, the heat source 23, the second vacuum pump 22 for O₂ scavenging, and the first vacuum pump 21 for desorption in the respective processing of the pressure-restoring processing, adsorption processing, O₂ purge processing, desorption processing and cooling processing in the case of performing carbon dioxide recovery with one module 11, and the elapse of time.

As shown in FIG. 5, in the case of performing a cycle for recovering carbon dioxide with one module 11, the fan 20 operates in the adsorption process, while it does not operate in the desorption process. Conversely, the heat source 23 operates in the desorption process, while it does not operate in the adsorption process. The second vacuum pump 22 for O₂ scavenging operates only in the O₂ purge processing, and the first vacuum pump 21 for desorption also does not operate other than operating in the desorption processing. In this way, the operation of each piece of equipment is intermittent operation, and requires momentary large outputs.

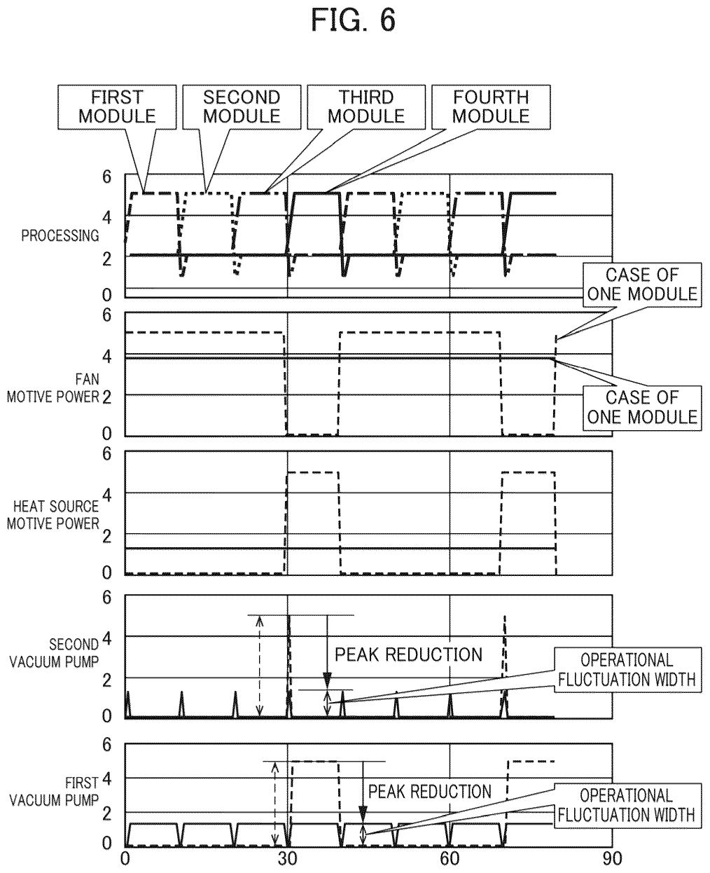

FIG. 6 is a graph showing the change in motive power of each piece of equipment with four of the modules 11. FIG. 6 shows, by the solid line, the change in output (motive power) for the pan 20, the heat source 23, the second vacuum pump 22 for O₂ scavenging, and the first vacuum pump 21 for desorption in the respective processing of the pressure-restoring processing, adsorption processing, O₂ purge processing, desorption processing and cooling processing in the case of performing carbon dioxide recovery with four of the module 11 by staggering in the time of cycles, together with the elapse of time. In addition, the operation changes in one module 11 are also illustrated in FIG. 6 by a broken line so as to be able to compare.

As shown in FIG. 6, in the case of performing the respective processing by making the cycles of carbon dioxide recovery different by the four modules 11 consisting of the first module 11, the second module 11, the third module 11 and the fourth module 11, the fan 20 and heat source 23 run continuously, and are not intermittent operation with the output change approaching constant. In addition, for the second vacuum pump 22 for O₂ scavenging and the first vacuum pump 21 for desorption, the output peak of the respective processing becomes small. By operating the plurality of modules 11 in a staggered manner in this way, the fan 20 and heat source 23 become efficiently operable with continuous running. In addition, in the fan 20, the heat source 23, the second vacuum pump 22 for O₂ scavenging, and the first vacuum pump 21 for desorption, it is possible to reduce the maximum capacity required in each piece of equipment, and thus the utilization of low cost equipment having relatively small capacity becomes possible.

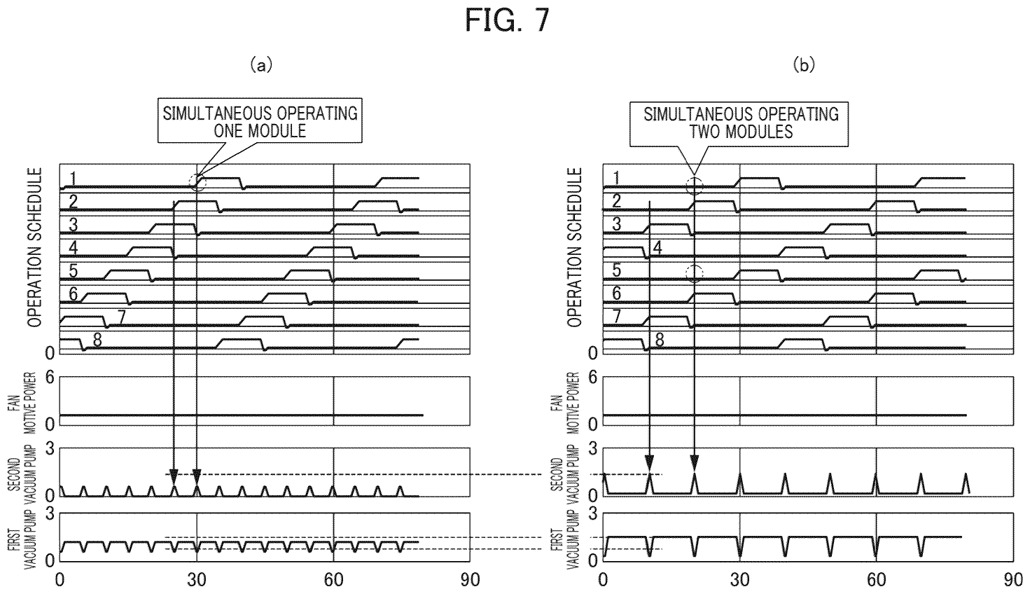

Next, a method of controlling so that the output of each device becomes equal in the carbon dioxide recovery device 1 using a plurality of modules 11 will be described by referencing FIG. 7. FIG. 7 is a graph showing an example of the respective processing timing of eight modules 11.

In FIG. 7(a), the change in output of each piece of equipment in the case of staggering the operation timings of all eight modules 11 is shown with the elapse of time. The operation schedules 1 to 8 in the graph indicate the operations of each module 11. For example, “1” in the graph indicates the first module 11, “2” indicates the second module 11, “3” indicates the third module 11, and thereafter, “4” to “8” correspond to the number of each module 11.

In the example of FIG. 7(a), the adsorption process and the desorption process are controlled so that the time difference between the modules 11 becomes equal, with the operation timings of the eight modules 11 all being staggered. Therefore, the number of module 11 operating simultaneously is one.

The time difference in operation timings between the eight modules 11 can be calculated from the following Equation (2). The time difference between modules is the interval between timings at which performing the same operation among different modules 11. For example, the time difference from when the adsorption process is started in the first module 11 until the adsorption process is started in the second module 11 is the time difference in operation timings. In the order of the first module 11, the second module 11, the third module 11 . . . the eighth module 11, the operation timings are delayed. The time difference in the operation timing between each module 11 are all the time difference calculated from the following Equation (2).

Time difference between modules=(adsorption time+desorption time)/number of modules Equation (2)

In this example, since there are no synchronous modules 11, the number of module 11 operating simultaneously is one.

FIG. 7(b) shows the change in output of each piece of equipment in the case of staggering the operation timings of the eight modules 11 with four modules 11 as one set, together with the elapse of time. In the example of FIG. 7(b), the total of eight modules 11 of two sets are operating. The processing of the first module 11 of the first set and the fifth module 11 of the second set is synchronized, the processing of the second module 11 of the first set and the sixth module 11 of the second set is synchronized, the processing of the third module 11 of the first set and the seventh module 11 of the second set is synchronized, and the fourth module 11 of the first set and the eighth module 11 of the second set is synchronized. In this example, since the number of synchronized modules 11 is two, the simultaneous operations are by two modules 11.

As found from comparison (refer to broken line in graph) between FIGS. 7(a) and 7(b), the operational fluctuation of the second vacuum pump 22 for O₂ scavenging and the first vacuum pump 21 for desorption becomes smaller for staggering the operation timings of all eight as in FIG. 7(a), compared to a case of only one module 11 operating simultaneously at the same operation timing as shown in FIG. 7(b). In this way, it is understood that having different operation timings of all modules 11 can make the required capacity of pieces of equipment smaller than if matching the operation timings of the modules 11.

Next, the setting method for the number of modules 11 will be described. As described by referencing FIGS. 5 and 6, having the number of modules 11 be a plurality is more advantageous in device configuration than only having one, due to staggering the operation timings. In the present embodiment, the number of modules 11 is set so as to correspond to the following Equation (1). In Equation (1), M indicates the number of modules 11, N indicates a natural number, and R indicates the ratio (adsorption time/desorption time) of adsorption time to desorption time.

M=N×(R+1) Equation (1)

In the present embodiment, since adsorption time: desorption time=3:1, the ratio (adsorption time/desorption time) R of adsorption time to desorption time will be 3. Therefore, the proper numbers of modules 11 are 4 (N=1), 8 (N=2), 12 (N=3), 16 (N=4) . . . .

It should be noted that, according to Equation (1), there is a possibility of M being a number with decimal places; however, the value of N is set so that the module number actually set is a natural number. For example, in the case of R=2.5, the natural number is an even number of 2, 4, 6, . . . , and the proper number of modules 11 becomes 7 (N=2), 14 (N=4), 21 (N=6). In addition, in the case of R=3.5, the natural number is an even number of 2, 4, 6, . . . , and the proper number of modules 11 becomes 9 (N=2), 18 (N=4), 27 (N=6). In other words, N is set so that the number of modules 11 becomes a natural number.

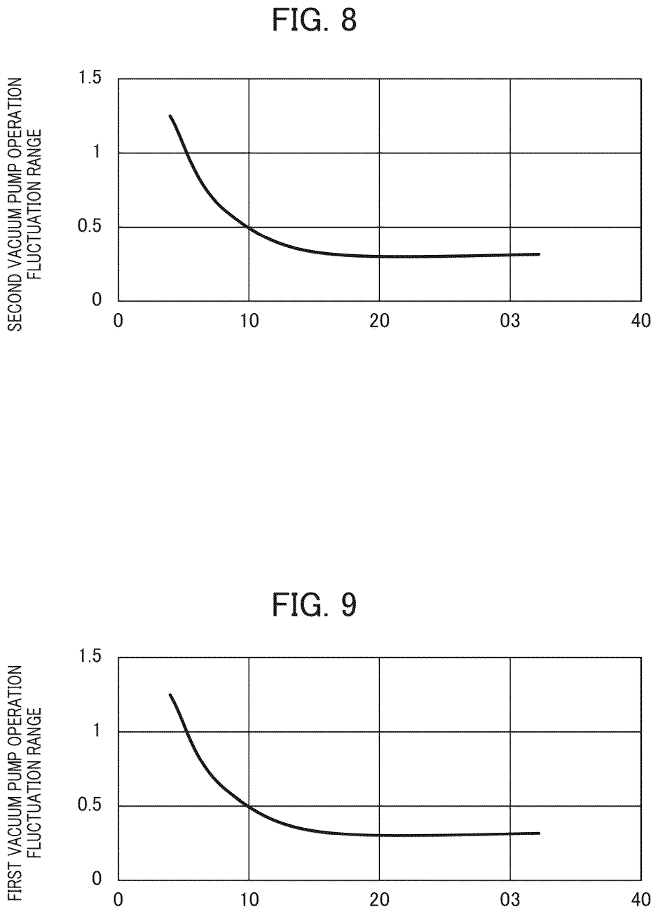

In this way, the proper number of modules 11 selected according to R, which is the ratio of adsorption/desorption time, will be a plurality. Next, the preferred range of numbers of the modules 11 will be described by referencing FIGS. 8 and 9. FIG. 8 is a graph showing the relationship between the number of modules 11 and the operational fluctuation range of the first vacuum pump 21. FIG. 9 is a graph showing the relationship between the number of modules 11 and the operational fluctuation range of the second vacuum pump 22. It should be noted that, in both FIGS. 8 and 9, the ratio (adsorption time/desorption time) R of the adsorption time to desorption time is set to 3. In addition, the operational fluctuation range is the power or output result required in driving of the equipment (first vacuum pump 21, second vacuum pump 22) illustrated in the graph of FIG. 6.

The graph of FIG. 8 shows a trend for the operational fluctuation range of the second vacuum pump 22 in which the operational fluctuation range becomes smaller with the number of modules 11 increasing, in the case of R=3. In particular, the operational fluctuation range is noticeably smaller when the number of modules 11 is 10 or more. In addition, it shows a trend, albeit very gradual, where the operation range is slightly larger when the number of modules 11 is 20 or more.

The graph of FIG. 9 also shows a trend for the operational fluctuation range of the first vacuum pump 21, in which the operational fluctuation range becomes smaller with the number of modules 11 increasing, in the case of R=3. Similarly to the second vacuum pump 22, the operational fluctuation range is noticeably smaller when the number of modules 11 is 10 or more. Here as well, it shows a trend, albeit very gradual, where the operation range becomes larger when the number of modules 11 is 20 or more.

In the graphs of both FIGS. 8 and 9, the preferred number of modules 11 is ten or more. In addition, from the graphs of FIGS. 8 and 9, it is understood that 10 or more and less than 20 is a more preferred range from the viewpoint of further decreasing the operational fluctuation range.

As described above, the carbon dioxide recovery device 1 according to the present embodiment includes: a plurality of modules 11, each one including the sorbent material 12 inside thereof, and executing an adsorption process of aspirating a gas containing carbon dioxide and adsorbing the carbon dioxide to the sorbent material 12; and a desorption process of desorbing the carbon dioxide from the sorbent material 12 by heating in a state where a periphery of the sorbent material 12 is reduced pressure; the fan 20 that supplies a gas to inside of the module 11; the heat source 23 that performs heat supply for heating the sorbent material 12 of the module 11; and the first vacuum pump 21 and the second vacuum pump 22 that aspirate a gas inside of the module 11, in which at least one among the fan 20, the heat source 23 the first vacuum pump 21 and the second vacuum pump 22 is shared between the plurality of the modules 11, and a number M of the modules 11 is set based on Equation (1) below, when defining a natural number as N and a ratio obtained by dividing an adsorption time of the sorbent material 12 by a desorption time as R.

$$M = N \times ( R + 1 ) \qquad Equation ( 1 )$$

By setting a number of modules 11 corresponding to the time ratio of each of adsorption/desorption of the sorbent material 12, and setting the operation schedule of each module 11, the operation of the adsorption process and desorption process in each module 11 is made continuous, whereby the energy consumption can be curbed. Since the energy consumption can be suppressed, pieces of equipment having smaller output and capacity (fan 20, heat source 23, first vacuum pump 21 and second vacuum pump 22) can be selected, and thus the running cost and manufacturing cost can be reduced.

In addition, in the present embodiment, the respective processing for executing the adsorption process and the desorption process are executed to be staggered so as not to be performed at the same timing among the plurality of modules 11. It is thereby possible to reliably avoid the occurrence of a situation where pieces of equipment (fan 20, heat source 23, first vacuum pump 21 and second vacuum pump 22) operate simultaneously, and the output momentarily rises.

In addition, with the present embodiment, the time calculated by dividing the sum of the adsorption time and the desorption time by the number M of modules 11 is set as the time difference in the operation timings between the modules 11. It is thereby possible to further equalize the operation time and output of each piece of equipment in the running time, the operation for realizing the respective processing of the adsorption process and desorption process can be made more constant, and thus the energy efficiency can be improved.

In addition, with the present embodiment, the number M of modules 11 is 10 or more. Since the operational fluctuation range can be made smaller as shown in FIGS. 8 and 9, pieces of equipment having smaller output and capacity can be selected.

Although embodiments of the present invention have been described above, it is not to be limited to the aforementioned embodiments and modified examples. In addition, the effects described in the above embodiments are merely exemplifying the preferred effects, and the effects thereof are not limited to those described in the above embodiments.

### EXPLANATION OF REFERENCE NUMERALS

1 carbon dioxide recovery device
11 module
12 sorbent material
20 fan
21 first vacuum pump
22 second vacuum pump
23 heat source

What is claimed is:

1. A carbon dioxide recovery device comprising:
a plurality of modules, each one including a sorbent material inside thereof, and executing an adsorption process of aspirating a gas containing carbon dioxide and adsorbing the carbon dioxide to the sorbent material; and a desorption process of desorbing the carbon dioxide from the sorbent material by heating in a state where a periphery of the sorbent material is reduced pressure;
a fan that supplies a gas to inside of the module;
a heat source that performs heat supply for heating the sorbent material of the module; and
a vacuum pump that aspirates a gas inside of the module,
wherein at least one among the fan, the heat source and the vacuum pump is shared between the plurality of the modules, and
a number M of the modules is set based on Equation (1) below, when defining a natural number as N and a ratio obtained by dividing an adsorption time of the sorbent material by a desorption time as R:
$$M = N \times ( R + 1 ) . \qquad Equation ( 1 )$$

2. The carbon dioxide recovery device according to claim 1, wherein respective processing for executing the adsorption process and the desorption process is executed in a staggered manner so as not to be performed at the same timing among the plurality of the modules.

3. The carbon dioxide recovery device according to claim 2, wherein a time calculated by dividing a sum of the adsorption time and the desorption time by the number M of the modules is set as a time difference of operation timings between the modules.

4. The carbon dioxide recovery device according to claim 2,
wherein the number M of the modules is 10 or more.

5. The carbon dioxide recovery device according to claim 3,
wherein the number M of the modules is 10 or more.
